(19) United States
(12) Patent Application Publication
(10) Pub. No.: US 2026/0310733 A1
(43) Pub. Date: Oct. 8, 2026

(54) SYSTEM AND METHOD FOR ARTIFICIAL INTELLIGENCE-BASED DATA STRUCTURING FOR DOCUMENT DATA OBJECTS

(71) Applicant: GALAXY US OPCO INC D/B/A VIALTO PARTNERS, Boston, MA (US)

(72) Inventors: Pavan Kumar NAGULA, Dallas, TX (US); Bhaskar MULUGU, Dallas, TX (US); Ashish VIRADIA, San Jose, CA (US); Akshay SHAH, San Jose, CA (US); Mitchell ROSS, Stamford, CT (US); Zahir ABBAS, Lakeville, MN (US)

(21) Appl. No.: 19/171,613

(22) Filed: Apr. 7, 2025

(51) Int. Cl. G06F 16/93; G06F 16/901; G06F 16/906; G06F 40/295; G06V 30/10; G06V 30/41

(52) U.S. Cl. CPC G06F 16/93; G06F 16/9024; G06F 16/906; G06F 40/295; G06V 30/10; G06V 30/41

(57) ABSTRACT

Systems and methods include techniques for automated management of a plurality of job description (JDs) data objects by converting unstructured data into structured, reusable templates. Leveraging advanced natural language processing (NLP) and machine learning, the techniques extract, cluster, and score job-related data to streamline the creation, storage, and retrieval of JDs. The techniques organize job titles, skills, qualifications, and experience into standardized data objects, indexed in a vector database for efficient search. A generative AI model can refine the templates to align with organizational standards, reducing manual input.

### BACKGROUND OF THE INVENTION

Traditionally, job description (JD) management involves manually drafting, categorizing, updating, and retrieving relevant job details, often based on disparate templates or prior documents. This conventional process is both labor-intensive and time-consuming (in the order of months), typically requiring human resources professionals to parse unstructured data, categorize job descriptions, and maintain a variety of templates for different job positions and requirements. The manual nature of this work often results inconsistencies, outdated templates, and delays, hindering an organization's ability to respond to dynamic hiring or immigration processing needs effectively. To address these challenges, advancements in data processing, natural language processing (NLP), and machine learning techniques have emerged as potential solutions to streamline job description management.

### SUMMARY

Embodiments detailed herein provide an automated job description management system overcome limitations in managing high volumes and diversity of job descriptions and ensuring similarity and accuracy in the templates produced, and further, via improved aligning extracted information with organizational and industry standards, creating reliable templates that capture the nuances of each job role, and enabling a streamlined search and retrieval system for fast access. Indeed, embodiments herein include techniques that leverages advanced data extraction, clustering, vector-based search indexing on nested-JSONs, similarity scoring, recommendations, and validation processes. The system addresses current challenges by chunking job description content into standardized sections, such as job details, skills, and education and experience requirements, transforming them into structured J SON chunks. These chunks are vectorized for storage within a vector-based search index, allowing for efficient retrieval based on similarity scoring and enabling quick, relevant access to job templates. Additionally, generative AI models create structured templates aligned with organizational needs, while validation mechanisms ensure accuracy and compliance. This approach streamlines the JD management process, significantly reduces manual work, and enables HR departments to respond rapidly to changing workforce needs.

In some aspects, the techniques described herein relate to a method including: obtaining a plurality of documents, each document representing unstructured data; performing optical character recognition on each document to produce document data associated with each document; utilizing at least one clustering model to cluster portions of the document data or each document into at least one nested database object of a plurality of nested database objects, wherein the plurality of nested database objects form a graph structure having a plurality of nodes representing the portions of the document data of each document; utilizing at least one large language model to generate, from the at least one nested database object, at least one document template document requirement; filtering a plurality of data profiles based at least in part on the at least one document template requirement to obtain at least one candidate data profile; and outputting, via a display, the at least one candidate data profile.

In some aspects, the techniques described herein relate to the method 1, wherein the plurality of documents include a plurality of job descriptions (JDs) in a structured format.

In some aspects, the techniques described herein relate to a method further including: receiving the plurality of job description documents in various formats; converting unstructured formats, using Optical Character Recognition (OCR) and Named Entity Recognition (NER); extracting the portions of the document data including job-related information; and organizing the job-related information into JSON sections, including job details, skills, education, and experience requirements, for storage in a database.

In some aspects, the techniques described herein relate to a method, wherein the structured J SON format organizes data into nested JSON elements, including at least one of JobDetailsRequirement, JobSkillsRequirement, or EducationAndExperienceRequirement, enabling modular access to distinct job requirements.

In some aspects, the techniques described herein relate to a method, further including: dividing each job description into structured JSON chunks at nested-J SON boundaries, where each chunk corresponds to distinct requirements such as JobDetailsRequirement, JobSkillsRequirement, and EducationAndExperienceRequirement. storing the J SON chunks in a structured database for efficient retrieval and modular management.

In some aspects, the techniques described herein relate to a method, further including a clustering algorithm to group a plurality of job descriptions with similar requirements based on attributes such as skills, experience, and education.

In some aspects, the techniques described herein relate to a method, further including clustering job descriptions to create templates, including: using similarity scoring techniques, including TF-IDF, cosine, or Jaccard similarity, to measure document similarity and identify clusters. generating a standardized template for each cluster using a generative AI model, ensuring alignment with industry standards. Storing templates in JSON format for modular access and retrieval.

In some aspects, the techniques described herein relate to a method, wherein clustering is performed using graph partitioning techniques that group job descriptions without a pre-specified number of clusters, allowing dynamic clustering based on similarity scores.

In some aspects, the techniques described herein relate to a method, further including using vector-based indexing and retrieval of job descriptions, including: converting sections i.e. nested-J SONs of job descriptions into vector representations using generative AI vector models. storing these vectors in a vector-based search index, allowing independent retrieval of structured sections.

In some aspects, the techniques described herein relate to a search and retrieval system for job description templates, including: parsing an input job description into structured sections and matching each section independently to stored templates. using relevance scoring to retrieve templates that most closely match the input job description.

In some aspects, the techniques described herein relate to a method for converting relevance score to similarity score by using cosine distance as a measure.

In some aspects, the techniques described herein relate to a method, further including retrieving a ranked list of relevant templates based on cumulative similarity scores.

In some aspects, the techniques described herein relate to a method, further including utilizing similarity scoring for job description retrieval, including: generating a TF-IDF matrix and similarity matrix (using metrics such as cosine or Jaccard similarity) between input job descriptions and stored templates; and calculating a cumulative similarity score by averaging/median of section-level scores, enabling the ranking and selection of templates that best align with the input job description.

In some aspects, the techniques described herein relate to a method, wherein similarity scores are further enhanced using alternative metrics such as vector embeddings for higher accuracy in template matching.

In some aspects, the techniques described herein relate to a recommendation and validation system for job descriptions, including: generating recommendations to adjust an input job description to align with a closest-matching template; validating recommendations by calculating similarity scores between the adjusted input and template; and identifying unique job descriptions as potential new templates if the adjusted input deviates from existing templates beyond a set threshold.

In some aspects, the techniques described herein relate to a system, wherein adjustments are guided by a configuration file that specifies acceptable ranges and conditions for each job attribute, ensuring consistency across templates.

In some aspects, the techniques described herein relate to a method for vector-based indexing and retrieval of job descriptions, including: converting sections of job descriptions into vector representations using generative AI. storing these vectors in a vector-based search index, allowing independent retrieval of structured sections.

In some aspects, the techniques described herein relate to a method, wherein each JSON chunk is vectorized and indexed independently, allowing for section-based similarity scoring and retrieval of specific job requirements, including job details, skills, and education sections.

In some aspects, the techniques described herein relate to a system for vector-based template assembly, including: storing vectorized JSON chunks within a search index. retrieving relevant J SON chunks based on vector similarity with sections in an input job description, enabling modular assembly of job description templates.

In some aspects, the techniques described herein relate to a machine-learning-based validation module for job description management, including: calculating similarity scores between new job descriptions and existing templates to determine alignment. identifying job descriptions that do not meet a similarity threshold as candidates for new template generation.

In some aspects, the techniques described herein relate to a system for managing job description templates, wherein each template is represented in a structured JSON format with nested JSON boundaries, allowing modular edits to individual sections according to specific job requirements.

In some aspects, the techniques described herein relate to a method for refining templates in job description management, including: adjusting similarity scores for templates based on industry standards and job-specific requirements, updating a template library with new job descriptions if existing templates fail to meet a minimum similarity threshold.

In some aspects, the techniques described herein relate to a method for structured job description retrieval, including: chunking each job description into nested JSON sections, vectorizing each section using a generative AI model, and indexing these vectors within a vector-based search system for rapid retrieval.

In some aspects, the techniques described herein relate to a method, further including performing section-level similarity scoring to retrieve only sections closely matching specific job requirements within an input job description.

In some aspects, the techniques described herein relate to a job description management system, including: dividing job descriptions into structured J SON sections at nested boundaries for distinct requirements; generating vector embeddings for each section using generative AI and storing these in a vector-based search index; and using similarity scoring to retrieve and assemble templates from independently matched sections, allowing efficient retrieval and customization of job descriptions based on specific organizational needs.

In some aspects, the techniques described herein relate to a method for processing job skills requirements from a job description text, including: identifying individual skills from the job description as required skills; categorizing the identified individual skills into a SkillSet section; extracting and organizing skill groups into a skillsGroup section from the job description based on logical relationships between skills, including “AND” and “OR” conditions. processing the logical relationships using a skillsGroupGate section, wherein: “AND” groups are treated as mandatory required groups “OR” groups occurring after an “AND” group are treated as either/or groups until the next “AND” group; Subsequent “AND” groups are treated as additional mandatory required groups; generating a structured representation of the job skills requirements by integrating the SkillSet, skillsGroup, and skillsGroupGate sections.

In some aspects, the techniques described herein relate to a method, wherein the SkillSet section includes individual skills that must be satisfied independently of the logical relationships within the skillsGroup section.

In some aspects, the techniques described herein relate to a method, wherein the skillsGroup section includes skill groups defined by the logical relationships, including: one or more skills combined using an “AND” condition to form a required group, and one or more skills combined using an “OR” condition to form an either/or group.

In some aspects, the techniques described herein relate to a method, further including dynamically updating the skillsGroupGate section when additional “AND” or “OR” conditions are identified in the job description text.

In some aspects, the techniques described herein relate to a method for generating strings to group or cluster JSON objects based on job skills requirements, including: constructing strings that represent the relationships within the SkillSet and skillsGroup sections, wherein: “AND” conditions are used to concatenate mandatory skills or groups; “OR” conditions are used to concatenate skills or groups that satisfy either/or conditions; ensuring the generated strings preserve the hierarchical and logical structure of the job skills requirements for accurate grouping or clustering of JSON objects.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is diagrams that illustrate the flowcharts of a job description management system, detailing each process involved in managing a plurality of job descriptions in accordance with one or more embodiments of the present disclosure.

FIG. 2A depicts an exemplary illustration of a Data Extraction Process to manage a plurality of job descriptions and the associated data within the Job Description Management System in accordance with one or more embodiments of the present disclosure.

FIG. 2B depicts an example demonstration of how group gating logic is processed in accordance with one or more embodiments of the present disclosure.

FIG. 3 depicts an illustrative flowchart for a template creation process in accordance with one or more embodiments of the present disclosure.

FIG. 4 depicts an exemplary scoring algorithm in accordance with one or more embodiments of the present disclosure.

FIG. 5 depicts an exemplary flowchart of a search and retrieval algorithm of the Job Description Management System in accordance with one or more embodiments of the present disclosure.

FIG. 6 depicts an exemplary flowchart of a recommendation and validation algorithm in the Job Description Management System in accordance with one or more embodiments of the present disclosure.

FIG. 7 depicts a block diagram of another exemplary computer-based system and platform 700 for the job description management system in accordance with one or more embodiments of the present disclosure.

### DETAILED DESCRIPTION OF THE INVENTION

Techniques herein provide an automated system for efficiently managing a plurality of job descriptions (JDs) by transforming, standardizing, and retrieving job-related data in a structured, reusable format. The system introduces a streamlined process that reduces manual effort and enhances accuracy, consistency, and speed in handling a plurality of JDs.

The core components of one or more embodiments include a data extraction module, a clustering and template generation process, a similarity-based search and retrieval mechanism, and a recommendation and validation system. The data extraction module captures job details from a plurality of document formats, converting them into structured JSON format by chunking them into sub-sections (e.g., job details, skills, education, and experience).

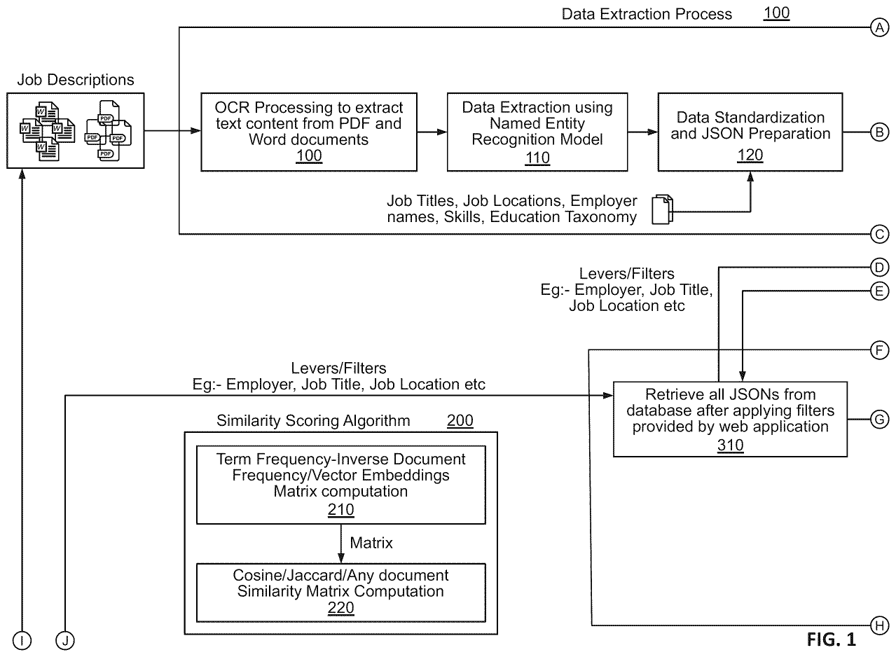

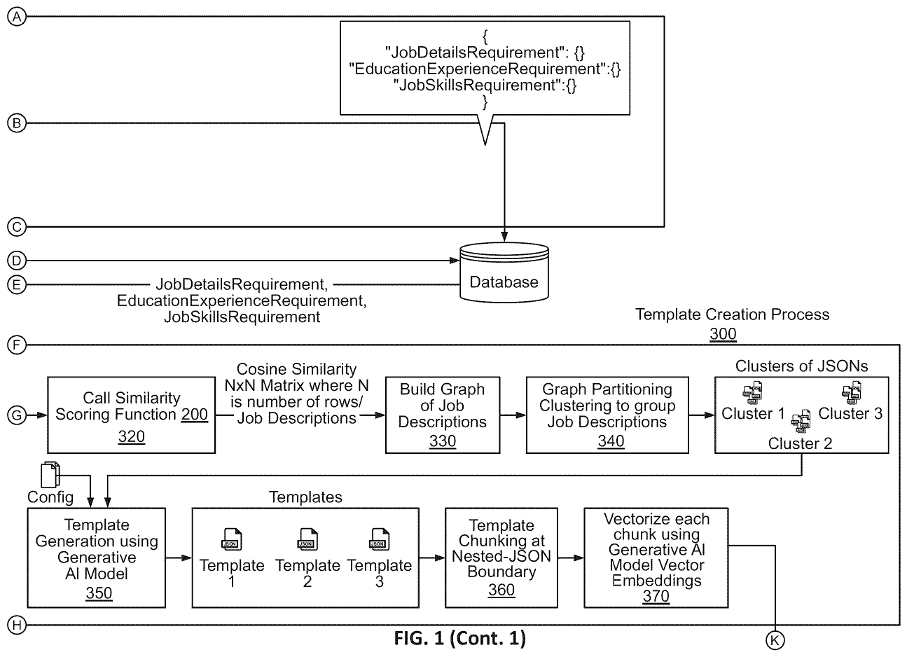

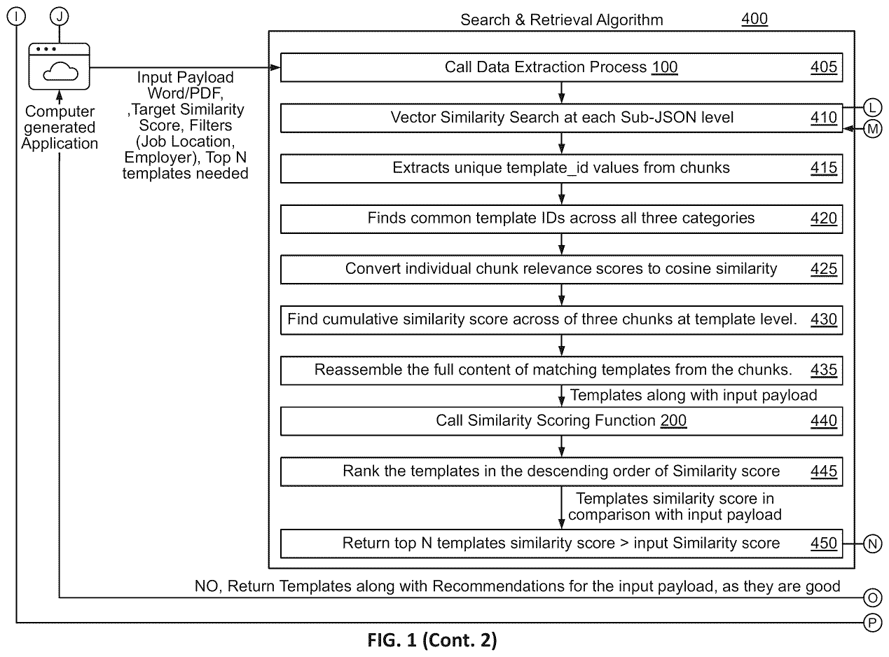

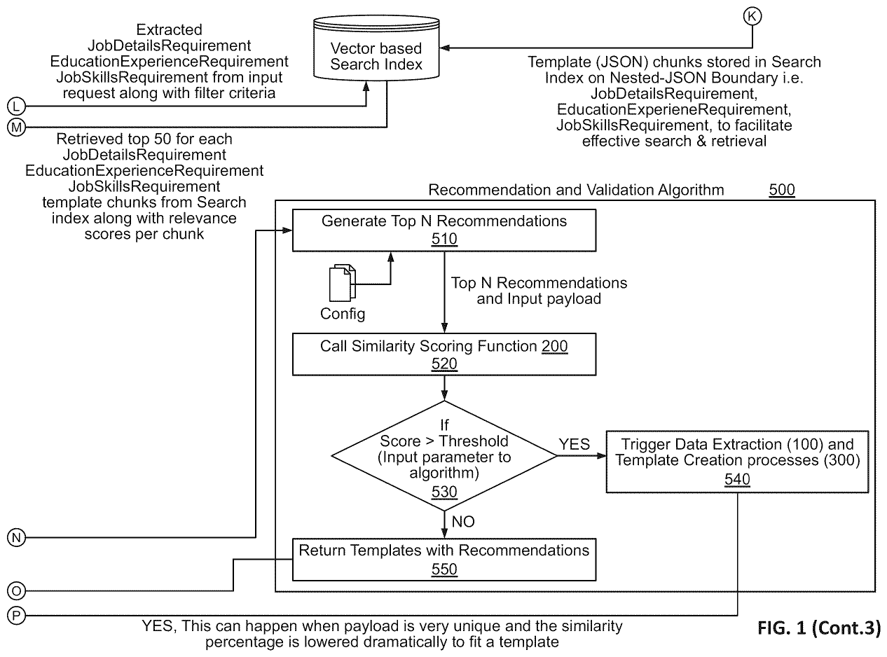

FIG. 1 is diagrams that illustrate the flowcharts of a job description management system for automated job description management, search, retrieval and recommendation system, detailing each process involved in managing a plurality of job descriptions in accordance with one or more embodiments of the present disclosure.

The diagram maps out the stages of data extraction, where a plurality of job-related information is parsed from various document formats and chunked into structured J SON format. It then progresses through the template creation process, where clustering techniques and generative AI produce a plurality of standardized templates. The flowchart further shows the similarity scoring mechanism, using methods like TF-IDF/Vector embeddings and Cosine/Jaccard/Any other document similarity to rank a plurality of templates by similarity. Next, the search and retrieval process enables modular, precise access to a plurality of templates based on specific job requirements, followed by the recommendation and validation stages, which fine-tune and align a plurality of templates with organizational needs. This comprehensive visual representation captures the system's end-to-end functionality, enhancing efficiency and adaptability in managing a plurality of job descriptions

The system clusters a plurality of similar job descriptions to facilitate template creation, using advanced techniques like cosine similarity and graph partitioning to group job descriptions with analogous features. A generative AI model for each cluster creates standardized templates that align with industry and organizational standards. These templates are stored in J SON format and optimized for easy access and customization. The structured data is chunked at the nested-J SON boundary, such as JobSkillsRequirement, JobDetailsRequirement, EducationAndExperienceRequirement, vectorized, and stored within a vector-based search index, enabling modular and precise retrieval based on specific job requirements.

The similarity scoring module ranks a plurality of templates by relevance to input job descriptions, employing techniques such as Term Frequency-Inverse Document Frequency (TF-IDF) and cosine similarity to achieve highly accurate template matches. During retrieval, the system breaks down job descriptions into their constituent chunks, matching each section independently and providing a ranked list of templates that best fit the requirements. Finally, a recommendation and validation module fine-tunes selected templates, ensuring alignment with organizational guidelines and user-specific criteria. This module also evaluates whether new or unique job descriptions might be valuable additions to the template library.

Overall, techniques herein introduce an end-to-end solution for JD management, addressing limitations in conventional approaches by incorporating modular data extraction, similarity-driven search, and intelligent template generation and validation. Such techniques can significantly reduce the time and effort required to manage a plurality of job descriptions from the order of months to a day while ensuring consistency, accuracy, and alignment with changing organizational needs

Typically, in job description management, automating portions of the job description (JD) lifecycle use keyword-based matching, hierarchical clustering, and some foundational and rudimentary forms of natural language processing (NLP) to categorize and search through a plurality of job descriptions. Often, job descriptions are converted into structured formats that allow retrieval and matching through a combination of predefined templates and taxonomies that align with industry standards. Matching engines within these systems typically rely on rule-based algorithms, which rank a plurality of candidates or JDs based on relevance to specified criteria, while some systems offer features to input job-specific requirements, thereby improving retrieval accuracy.

Embodiments herein advance job description management by introducing structured data transformation, graph-based clustering, and vector-based search to address limitations in typical job description management automation. Unlike traditional keyword-matching or single-template models, it modularizes a plurality of job descriptions into sections like “JobDetailsRequirement”, “JobSkillsRequirement”, and “EducationAndExperienceRequirement” enabling precise, chunk-level retrieval based on relevance. Advanced clustering techniques, such as graph-based partitioning, group similar job descriptions, allowing a generative AI model to produce standardized templates that align with industry standards and organizational needs. Vector-based similarity scoring ensures accurate matches beyond basic keyword presence, while a generative AI based recommendation and validation module offers real-time customization aligned with specific requirements and also identifies potential job descriptions to be a template. This automated, adaptive system drastically reduces manual effort, completing tasks in hours rather than weeks, and enables scalable, high-accuracy management of a plurality of job descriptions that evolve with changing workforce demands.

The system includes the following components: a Data Extraction Process, a Template Creation Process, a Similarity Scoring Algorithm, a Search and Retrieval Algorithm, and a Recommendation and Validation Algorithm.

### 1. Data Extraction Process

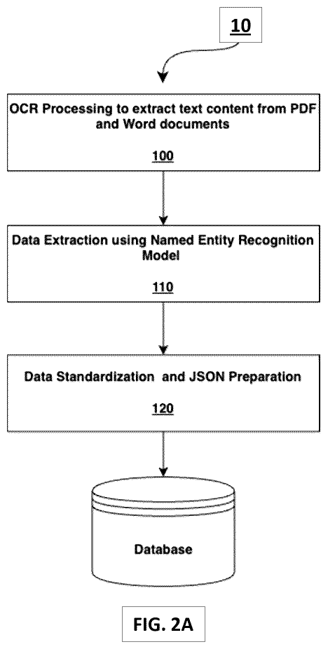

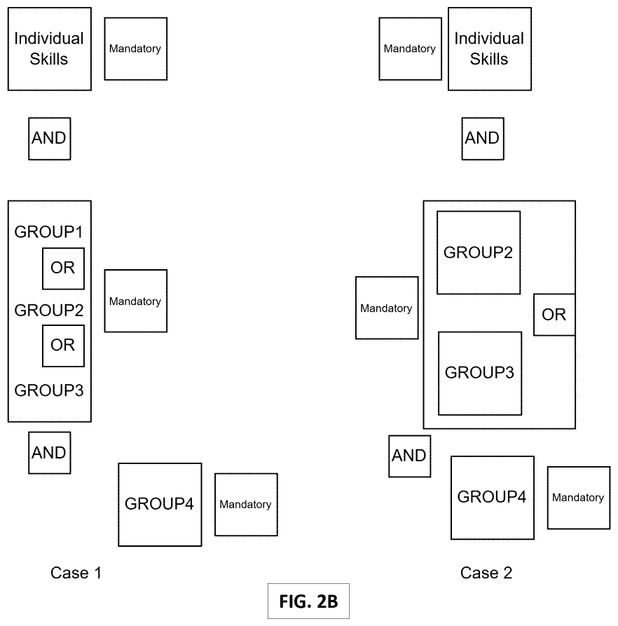

FIG. 2A depicts an exemplary illustration of a Data Extraction Process to manage a plurality of job descriptions and the associated data within the Job Description Management System in accordance with one or more embodiments of the present disclosure.

A Data Extraction Process may manage a plurality of job descriptions within the Job Description Management System, as shown in FIG. 2A. The data extraction process may capture a plurality of key information elements from job description (J D) documents. Since these documents can be in a plurality of diverse formats, such as unstructured text, PDFs, and scanned images, a precise and consistent approach provides improvements for accurate extraction.

Technologies like Optical Character Recognition (OCR) may be employed for a plurality of scanned images or PDFs (step 100). OCR converts visual text into machine-readable characters, while Named Entity Recognition (NER), through machine learning or generative AI, identifies and extracts a plurality of details available in JSONs JobDetailRequirement, JobSkillsRequirement and EducationAndExperienceRequirement (step 110). To ensure consistency, a plurality of extracted data points is standardized using a taxonomy that aligns job titles, locations, employer names, skills, and educational qualifications into uniform formats and structures (step 120). The standardized data is then converted into JSON with a plurality of nested JSONs, including JobDetailRequirement, JobSkillsRequirement, and EducationAndExperienceRequirement. While extracting skills from the job description text, the individual skills can be identified as “required skills” and have to be satisfied individually, these are placed under the SkillSet section of the JobSkills of the JobSkillsRequirement. The group gate section i.e. skillsGroup includes the AND/OR conditions that exist between skills e.g:—“Python AND Java”, “Unix OR MacOS” etc. Consider an “AND” group as a required group. If an “OR” group occurs after an “AND” group, then it is treated as an either/or group till another “AND” group occurs, where the next “AND” group will be another required group.

FIG. 2B depicts an example demonstration of how group gating logic is processed in accordance with one or more embodiments of the present disclosure.

As depicted in FIG. 2B, case 1 is processed as Individual skills AND (Skills Group 1 OR Skills Group 2 OR Skills Group 3) AND Skills Group 4. Case 2 is processed as Individual skills AND (Skills Group 2 OR Skills Group 3) AND Skills Group 4. The group gates are placed in the section skillsGroup and individual skills are placed in the section SkillSet. skillsGroupGate includes the AND/OR conditions that exist between the skills.

The plurality of JSON objects can be stored in a structured database, laying a reliable groundwork for further processes like similarity scoring, clustering, and search and retrieval. With a consistent data structure, the system can easily identify and match a plurality of similar job descriptions, streamlining JD management. This automated extraction process significantly reduces manual work by pulling a plurality of information from various sources and making it readily available for template creation and other downstream tasks.

### 2. Template Creation Process

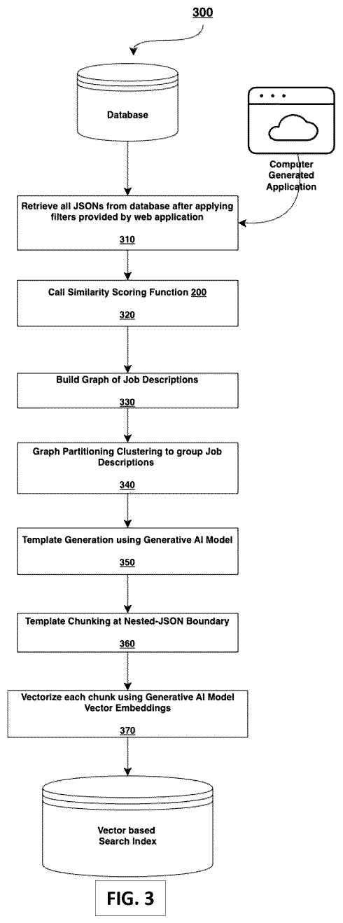

FIG. 3 depicts an illustrative flowchart for a template creation process the Job Description Management System in accordance with one or more embodiments of the present disclosure.

In some embodiments, as shown in FIG. 3, a template creation process (300) streamlines the management of a plurality of job descriptions, allowing HR teams and other enterprise users to quickly access and customize a plurality of templates for new job descriptions. The plurality of templates may align closely with industry and organizational standards by clustering a plurality of job descriptions with similar features, such as education, skills, and experience, ensuring relevance and practicality in the process. To achieve this, the process utilizes the graph partitioning clustering technique (step 330). This method is advantageous because it does not require specifying the number of clusters in advance and is well-suited to handle the high-dimensional data common in a plurality of job descriptions, where traditional methods like K-Means may fall short.

In some embodiments, in the template creation process (300), a plurality of JSON files from the database can be retrieved after applying filters specified by the computer generated application. Values from three key sections JobDetailsRequirement, JobSkillsRequirement, and EducationAndExperienceRequirement are combined into comma-separated strings, skillsGroupGate conditions such as AND/OR are taken care while making up comma-separated strings eg:—“Oracle”, “Python And Java”, “SQL Or NoSQL”. These strings may be passed to the similarity scoring function (process 200) to compute a TF-IDF matrix (step 210), followed by a cosine similarity matrix (step 220). While the system may employ cosine similarity for measuring similarity, it may also supports alternative scoring methods, like Jaccard similarity or word embeddings, to enhance the accuracy of matching a plurality of templates. As per step 320, a graph is built where each node represents a job description, and edges connect nodes with a cosine similarity above the median or mean score of the cosine similarity matrix. The graph is then analyzed using the Leiden algorithm to identify clusters, grouping a plurality of job descriptions with common features (step 330). Clusters are created based on filters such as job titles, locations, employers and other filters as available in JSON JobDetailsRequirement provided by the computer generated application (step 310).

Each cluster represents a category of job descriptions sharing a similar structure in skills, education, and experience for a plurality of employers, job titles, job locations and other filters. A generative AI model creates a template for each cluster that captures the typical structure and essential content of that category (step 340). A configuration file is provided to guide the generative AI model to resolve conflicts if a plurality of JSONs have different values for the same key. These templates are chunked into sections (e.g., JobDetailsRequirement, JobSkillsRequirement, EducationAndExperienceRequirement) (step 350) and vectorized using generative AI model vector embeddings at the nested J SON level, then stored as standardized JSON chunks in a vector-based search index (step 360). This approach ensures that each section is given equal importance, preventing templates from being selected based solely on heavy similarity in only one area.

### 3. Similarity Scoring Algorithm

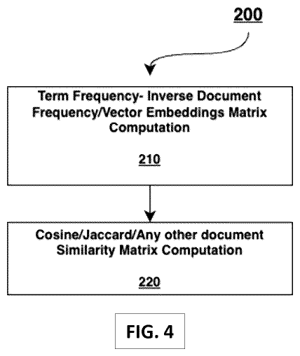

FIG. 4 depicts an exemplary scoring algorithm the Job Description Management System in accordance with one or more embodiments of the present disclosure.

In some embodiments, a similarity scoring algorithm (process 200) may evaluate how well a new job description aligns with a plurality of existing templates and, more broadly, how related a plurality of text elements are. This functionality can be used within the system, supporting a plurality of processes like template creation, search and retrieval, and recommendation and validation. The similarity scoring algorithm (process 200) may apply mathematical techniques like TF-IDF (Term Frequency-Inverse Document Frequency)/Vector Embeddings (step 210) and cosine/Jaccard/any other document similarity (step 220) to gauge each template's similarity to the input job description, as shown in FIG. 3. While the system may employ cosine similarity for measuring similarity, the system may also or instead support a plurality of alternative scoring methods, such as Jaccard similarity or word embeddings, to improve the accuracy of template matching.

TF-IDF measures the significance of words in each document by assigning higher scores to terms that appear frequently within a single document but not across a plurality of documents and vector embedding tries to deduce semantic meaning of the text (step 210). Cosine similarity calculates the angle between two vectors in a multidimensional space, where each vector represents either a job description or a template (step 220). A smaller angle (or higher cosine similarity score) denotes a closer match between a plurality of texts. Jaccard similarity is a statistic used for gauging the similarity and diversity of sample sets.

Through similarity scoring, a plurality of templates can be ranked by similarity, enabling the system to present the most appropriate templates to users. This process may facilitate more efficient retrieval, ensuring that only templates closely matching the job description are selected. Implementing similarity scoring enhances the accuracy of matching a plurality of templates, helping users save time by filtering out irrelevant templates.

### 4. Search & Retrieval Algorithm

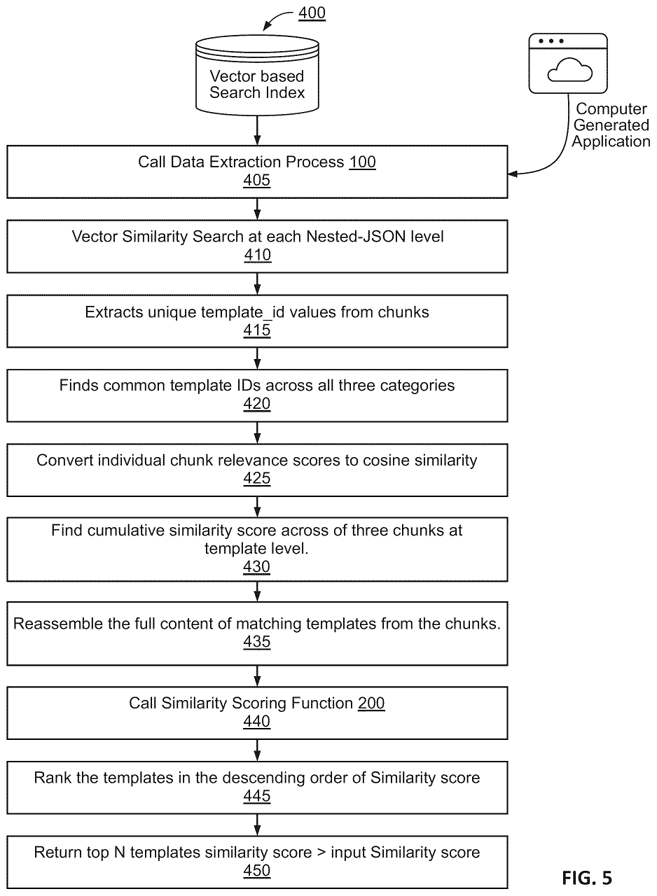

FIG. 5 depicts an exemplary flowchart of a search and retrieval algorithm of the Job Description Management System in accordance with one or more embodiments of the present disclosure.

In some embodiments, a search and retrieval algorithm, as depicted in FIG. 4, which ensures that a plurality of relevant templates can be identified and provided to the application efficiently. The search and retrieval algorithm component minimizes the effort required to find a plurality of suitable templates by presenting a ranked list that closely matches the input job description. The process begins with an input payload provided by the computer generated application containing a plurality of sections, such as JobDetailsRequirements, EducationAndExperienceRequirements, and JobSkillsRequirements, as well as parameters for the desired similarity score, filters, and the number of top templates to retrieve.

The process may call data extraction process 10 to extract sections JobDetailsRequirements, EducationAndExperienceRequirements, and JobSkillsRequirements from plurality of job descriptions which are word or pdf documents. The process receives filters, target similarity percentage and top N templates required from the input payload (step 405). Each section can be independently searched within a vector-based index to retrieve a plurality of relevant chunks associated with a relevance score (step 410). Template IDs are extracted from these chunks, and only those IDs common to all three sections are retained, ensuring each selected template includes a plurality of relevant sections (steps 415 & 420). This filtering ensures that only fully matched templates are identified, rather than those with partial matches. Relevance scores are then converted to cosine similarity scores for each chunk (step 425) using the formula:

$$cosineDistance = ( 1 - score ) / score \\ similarity\_score = - cosineDistance + 1$$

At the template level, the cumulative similarity score across a plurality of sections is calculated by averaging the cosine similarity scores, providing an overall similarity score relative to the input payload (step 430). The process can then reassemble the full content of each matching template from the plurality of retrieved chunks, resulting in a complete set of templates corresponding to the number of retrieved chunks (step 435).

The search and retrieval algorithm concludes by calling process 200 to create a TF-IDF matrix for all reassembled templates and computing a cosine similarity matrix between the input payload and each of the plurality of templates (step 440). This similarity matrix ranks the plurality of templates in descending order, returning the top N templates that meet or exceed the similarity threshold specified in the input (steps 445 & 450). This final step is essential for ranking a plurality of templates based on their similarity to the input payload.

### 5. Recommendation and Validation Algorithm

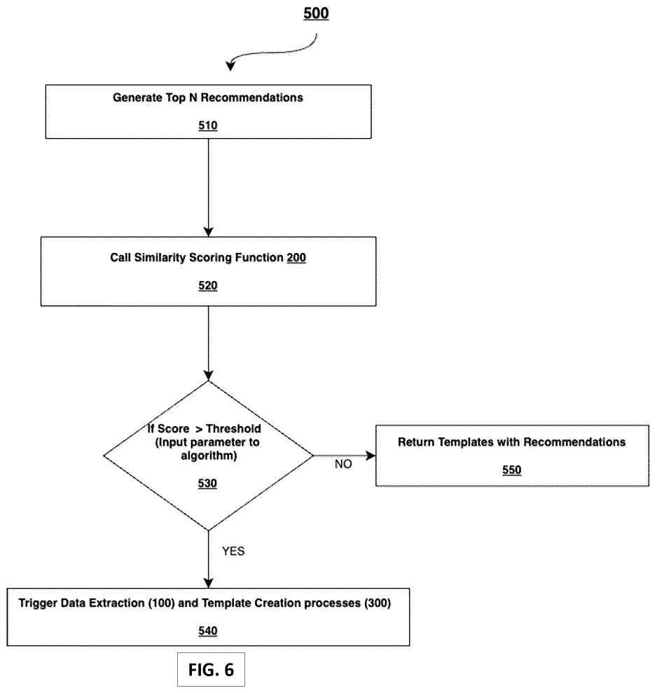

FIG. 6 depicts an exemplary flowchart of a recommendation and validation algorithm in the Job Description Management System in accordance with one or more embodiments of the present disclosure.

In some embodiments, a recommendation and validation algorithm (500) may refine a plurality of selected templates to ensure that the templates accurately align with the specific requirements of the new job description. A generative AI model can generate a plurality of recommendations for adjusting the input payload to best match each of the top N templates (step 510). This process may be guided by a configuration file that directs the AI model, specifying acceptable ranges and boundary conditions e.g.: 1. If input payload jobBand is L1 and best matching template has L2, then template is the winner and jobB and can be constrained to L1, L2, L3 and to not generate any combinations, and 2. if input payload percentTravel is, e.g., 50% and best matching template is, e.g., 75% then its ok to generate a range, such as 50-75, can be generated while percentTravel can be constrained to less than or equal to, e.g., 80%. Such ranges and boundaries can vary in any range suitable for ensuring templates accurately align with the specific requirements of an associated job description, and be predefined, configurable, dynamically/algorithmically generated, generated by machine learning and/or artificial intelligence, or any combination thereof.

The system validates these recommendations, as shown in step 520, by calling process 200 to compute a TF-IDF matrix and a cosine similarity matrix between the plurality of top recommendations and the input payload. As shown in step 530, if the cosine similarity score exceeds a certain threshold e.g.: 60%, 65%, 70%, 75%, 80%, 85% or any other suitable threshold, e.g., within a range of about 50% to 99%, it indicates that substantial changes are needed for the input payload to align with the plurality of recommendations. In such cases, as per step 540, if the input payload is highly unique, it may be more suitable to convert it into a template, triggering the data extraction and template creation processes (process 10 and 300). When this happens, the similarity threshold in the input payload can be lowered to retrieve any potential matching templates, with the validation score confirming that the payload should indeed become a new template. In cases where the cosine similarity does not exceed the threshold, the top N templates, along with a plurality of recommendations, are returned to the application (step 550).

This recommendation and validation algorithm enhances the job description management system's reliability, ensuring minimal adjustments are needed to adapt the input payload to a plurality of existing templates. Additionally, the validation process identifies payloads that may serve as valuable new templates, preserving the system's accuracy and comprehensiveness. An example of code for the Job Description JSON Structure with nested-J SONs of embodiments is provided as follows:

```
JobDetailsRequirement, JobSkillsRequirement, EducationAndExperienceRequirement.
public class PositionRequirements
{
  public JobDetailsRequirementjobDetailsRequirements { get; set; }
      publicEducationAndExperienceRequirement
educationAndExperienceRequirements { get; set; }
  publicJobSkillsRequirementjobSkillsRequirements { get; set; }
  public WorkAddressRequirementWithM saCode? workAddress { get; set; }
}
public classJobDetailsRequirement
  {
    /*
      “jobTitle”: “Software Analyst 2”,
      “jobBand”: “L2”,
      “businessUnit”: “IT”,
      “jobDescription”: “<p>Desc</p>”
      “isSupervisorRole”: “yes”,
      “supervisionLevel”: “peer”,
      “isTelecommuteRole”: “yes”,
      “percentTelecommute”: 100,
      “isTravelRole”: “yes”,
      “percentTravel”: 100,
      “travelType”: “both”
    */
    [JsonPropertyName(“jobTitle”)]
    public string jobTitle { get; set; }
    [JsonPropertyName(“jobBand”)]
    public string jobBand { get; set; }
    [JsonPropertyName( “businessUnit”) ]
    public string businessUnit { get; set; }
    [JsonPropertyName(“jobDescription”)]
    public string jobDescription { get; set; }
    [JsonPropertyName(“isSupervisorRole”)]
    public string isSupervisorRole { get; set; }
    [JsonPropertyName(“supervisionLevel”)]
    public string supervisionLevel { get; set; }
    [JsonPropertyName(“isTelecommuteRole”)]
    public string isTelecommuteRole { get; set; }
    [JsonPropertyName(“percentTelecommute”)]
    public int percentTelecommute { get; set; }
    [JsonPropertyName(“isTravelRole”)]
    public string isTravelRole { get; set; }
    [JsonPropertyName(“percentTravel”)]
    public int percentTravel { get; set; }
    [JsonPropertyName( “travelType”) ]
    public string? travelType { get; set; }
  }
public class EducationAndExperienceRequirement
  {
    /*
      “minEducation”: “other”,
      “altEducation”: “Some education diploma”,
      “fieldOfStudy”: “Software”,
      “isLicenseRequired”: “yes”,
      “licenseDetails”: “React”,
      “minWorkExperienceM ”: “gt60”,
      “businessReasons”: “Some reason”,
      “broadFieldOfExperience”: “Software development”
    */
    [JsonPropertyName(“minEducation”)]
    public string minEducation { get; set; }
    [JsonPropertyName( “altEducation”)]
    public string altEducation { get; set; }
    [JsonPropertyName(“fieldOfStudy”)]
    public string fieldOfStudy { get; set; }
    [JsonPropertyName(“isLicenseRequired”)]
    public string isLicenseRequired { get; set; }
    [JsonPropertyName( “licenseDetails”)]
    public string licenseDetails { get; set; }
    [JsonPropertyName(“minWorkExperienceM ”)]
    public string minWorkExperienceM { get; set; }
    [JsonPropertyName(“businessReasons”)]
    public string businessReasons { get; set; }
    [JsonPropertyName(“broadFieldOfExperience”)]
    public string broadFieldOfExperience { get; set; }
    [JsonPropertyName(“altEducationAndExp”)]
    public List<AltEducationAndExperience>altEducationAndExp{ get; set; }
  }
public class AltEducationAndExperience
  {
    public string altMinEducation { get; set; }
    public string altMinWorkExperienceM { get; set; }
    public string otherAltEducation { get; set; }
  }
public class JobSkillsRequirement
  {
    [JsonPropertyName(“skills”)]
    public List<JobSkills>? skills { get; set; }
    [JsonPropertyName(“skillsGroup”)]
    public List<SkillsGroup>? skillsGroup { get; set; }
  }
  public class JobSkills
  {
    [JsonPropertyName(“skill”)]
    public SkillSet skill { get; set; }
    [JsonPropertyName(“skillsMinExpM ”)]
    public string skillsMinExpM { get; set; }
  }
  public class SkillSet
  {
    [JsonPropertyName(“label”)]
    public string label { get; set; }
    [JsonPropertyName(“value”)]
    public string value { get; set; }
  }
  public class SkillsGroup
  {
    [JsonPropertyName(“skills”)]
    public List<SkillSet>? skills { get; set; }
    [JsonPropertyName(“minSkillsReqdInGroup”)]
    public string? minSkillsReqdInGroup { get; set; }
    [JsonPropertyName(“skillsM inExpGroupM ”)]
    public string? skillsMinExpGroupM { get; set; }
    [JsonPropertyName(“skillsGroupGate”)]
    public string? skillsGroupGate { get; set; }
  }
public class WorkAddressRequirementWithM saCode
  {
    /*
      “employerAddress1”: “Address1”,
      “employerAddress2”: “address 2”,
      “employerCountry”: “IN”,
      “employerState”: “WB”,
      “employerCity”: “Kolkata”,
      “employerZip”: “700061“
    */
    [JsonPropertyName(“employerEntity”)]
    public string employerEntity { get; set; }
    [JsonPropertyName(“employerAddress1”)]
    public string employerAddress1 { get; set; }
    [JsonPropertyName(“employerAddress2”)]
    public string employerAddress2 { get; set; }
    [JsonPropertyName(“employerCountry”)]
    public string employerCountry { get; set; }
    [JsonPropertyName( “employerState”)]
    public string employerState { get; set; }
    [JsonPropertyName(“employerCity”)]
    public string employerCity { get; set; }
    [JsonPropertyName(“employerZip”)]
    public string employerZip { get; set; }
    [JsonPropertyName(“employerM SA Code”)]
    public string employerMSA Code { get; set; }
  }
```

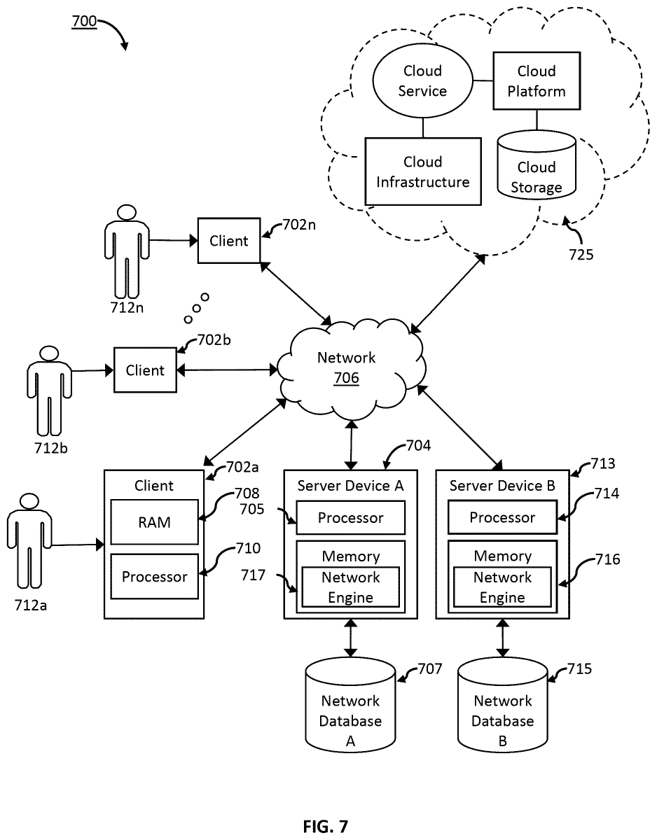

FIG. 7 depicts a block diagram of another exemplary computer-based system and platform 700 for the job description management system in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the client device 702a, client device 702b through client device 702n shown each at least includes a computer-readable medium, such as a random-access memory (RAM) 708 coupled to a processor 710 or FLASH memory. In some embodiments, the processor 710 may execute computer-executable program instructions stored in memory 708. In some embodiments, the processor 710 may include a microprocessor, an A SIC, and/or a state machine. In some embodiments, the processor 710 may include, or may be in communication with, media, for example computer-readable media, which stores instructions that, when executed by the processor 710, may cause the processor 710 to perform one or more steps described herein. In some embodiments, examples of computer-readable media may include, but are not limited to, an electronic, optical, magnetic, or other storage or transmission device capable of providing a processor, such as the processor 710 of client device 702a, with computer-readable instructions. In some embodiments, other examples of suitable media may include, but are not limited to, flash drive, solid state drive, hard drive, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, client devices 702a through 702n may also comprise a number of external or internal devices such as a mouse, a CD-ROM, DVD, a physical or virtual keyboard, a display, or other input or output devices. In some embodiments, examples of client devices 702a through 702n (e.g., clients) may be any type of processor-based platforms that are connected to a network 706 such as, without limitation, personal computers, digital assistants, personal digital assistants, smart phones, pagers, digital tablets, laptop computers, Internet appliances, and other processor-based devices. In some embodiments, client devices 702a through 702n may be specifically programmed with one or more application programs in accordance with one or more principles/methodologies detailed herein. In some embodiments, client devices 702a through 702n may operate on any operating system capable of supporting a browser or browser-enabled application, such as Microsoft™, Windows™, and/or Linux. In some embodiments, client devices 702a through 702n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 702a through 702n, user 712a, user 712b through user 712n, may communicate over the exemplary network 706 with each other and/or with other systems and/or devices coupled to the network 706. As shown in FIG. 7, exemplary server devices 704 and 713 may include processor 705 and processor 714, respectively, as well as memory 717 and memory 716, respectively. In some embodiments, the server devices 704 and 713 may be also coupled to the network 706. In some embodiments, one or more client devices 702a through 702n may be mobile clients.

In some embodiments, at least one database of exemplary databases 707 and 715 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBM S-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBM S-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

In some embodiments, the exemplary inventive computer-based systems/platforms, the exemplary inventive computer-based devices, and/or the exemplary inventive computer-based components of the present disclosure may be specifically configured to operate in a cloud computing/architecture 725 such as, but not limiting to: infrastructure a service (IaaS), platform as a service (PaaS), and/or software as a service (Saas) using a web browser, mobile app, thin client, terminal emulator or other endpoint.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDK s), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24).NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.

Clause 1. A method comprising: obtaining a plurality of documents, each document representing unstructured data; performing optical character recognition on each document to produce document data associated with each document; utilizing at least one clustering model to cluster portions of the document data or each document into at least one nested database object of a plurality of nested database objects, wherein the plurality of nested database objects form a graph structure having a plurality of nodes representing the portions of the document data of each document; utilizing at least one large language model to generate, from the at least one nested database object, at least one document template document requirement; filtering a plurality of data profiles based at least in part on the at least one document template requirement to obtain at least one candidate data profile; and outputting, via a display, the at least one candidate data profile.

Clause 2. The method 1, wherein the plurality of documents comprise a plurality of job descriptions (JDs) in a structured format.

Clause 3. The method of clause 2 further comprising: receiving the plurality of job description documents in various formats; converting unstructured formats, using Optical Character Recognition (OCR) and Named Entity Recognition (NER); extracting the portions of the document data comprising job-related information; and organizing the job-related information into JSON sections, including job details, skills, education, and experience requirements, for storage in a database.

Clause 4. The method of clause 2, wherein the structured JSON format organizes data into nested JSON elements, comprising at least one of JobDetailsRequirement, JobSkillsRequirement, or EducationAndExperienceRequirement, enabling modular access to distinct job requirements.

Clause 5. The method of clause 2, further comprising: dividing each job description into structured J SON chunks at nested-J SON boundaries, where each chunk corresponds to distinct requirements such as JobDetailsRequirement, JobSkillsRequirement, and EducationAndExperienceRequirement. storing the J SON chunks in a structured database for efficient retrieval and modular management.

Clause 6. The method of clause 3, further comprising a clustering algorithm to group a plurality of job descriptions with similar requirements based on attributes such as skills, experience, and education.

Clause 7. The method of clause 3, further comprising clustering job descriptions to create templates, comprising: using similarity scoring techniques, including TF-IDF, cosine, or Jaccard similarity, to measure document similarity and identify clusters. generating a standardized template for each cluster using a generative AI model, ensuring alignment with industry standards. Storing templates in J SON format for modular access and retrieval.

Clause 8. The method of clause 5, wherein clustering is performed using graph partitioning techniques that group job descriptions without a pre-specified number of clusters, allowing dynamic clustering based on similarity scores.

Clause 9. The method of clause 5, further comprising using vector-based indexing and retrieval of job descriptions, comprising: converting sections i.e. nested-JSONs of job descriptions into vector representations using generative AI vector models. storing these vectors in a vector-based search index, allowing independent retrieval of structured sections.

Clause 10. A search and retrieval system for job description templates, comprising: parsing an input job description into structured sections and matching each section independently to stored templates. using relevance scoring to retrieve templates that most closely match the input job description.

Clause 11. A method for converting relevance score to similarity score by using cosine distance as a measure.

Clause 12. The method of clause 11, further comprising retrieving a ranked list of relevant templates based on cumulative similarity scores.

Clause 13. The method of clause 2, further comprising utilizing similarity scoring for job description retrieval, comprising: generating a TF-IDF matrix and similarity matrix (using metrics such as cosine or Jaccard similarity) between input job descriptions and stored templates; and calculating a cumulative similarity score by averaging/median of section-level scores, enabling the ranking and selection of templates that best align with the input job description.

Clause 14. The method of clause 8, wherein similarity scores are further enhanced using alternative metrics such as vector embeddings for higher accuracy in template matching.

Clause 15. A recommendation and validation system for job descriptions, comprising: generating recommendations to adjust an input job description to align with a closest-matching template; validating recommendations by calculating similarity scores between the adjusted input and template; and identifying unique job descriptions as potential new templates if the adjusted input deviates from existing templates beyond a set threshold.

Clause 16. The system of clause 10, wherein adjustments are guided by a configuration file that specifies acceptable ranges and conditions for each job attribute, ensuring consistency across templates.

Clause 17. A method for vector-based indexing and retrieval of job descriptions, comprising: converting sections of job descriptions into vector representations using generative AI. storing these vectors in a vector-based search index, allowing independent retrieval of structured sections.

Clause 18. The method of clause 12, wherein each JSON chunk is vectorized and indexed independently, allowing for section-based similarity scoring and retrieval of specific job requirements, including job details, skills, and education sections.

Clause 19. A system for vector-based template assembly, comprising: storing vectorized JSON chunks within a search index. retrieving relevant J SON chunks based on vector similarity with sections in an input job description, enabling modular assembly of job description templates.

Clause 20. A machine-learning-based validation module for job description management, comprising: calculating similarity scores between new job descriptions and existing templates to determine alignment. identifying job descriptions that do not meet a similarity threshold as candidates for new template generation.

Clause 21. A system for managing job description templates, wherein each template is represented in a structured J SON format with nested J SON boundaries, allowing modular edits to individual sections according to specific job requirements.

Clause 22. A method for refining templates in job description management, comprising: adjusting similarity scores for templates based on industry standards and job-specific requirements, updating a template library with new job descriptions if existing templates fail to meet a minimum similarity threshold.

Clause 23. A method for structured job description retrieval, comprising: chunking each job description into nested J SON sections, vectorizing each section using a generative AI model, and indexing these vectors within a vector-based search system for rapid retrieval.

Clause 24. The method of clause 18, further comprising performing section-level similarity scoring to retrieve only sections closely matching specific job requirements within an input job description.

Clause 25. A job description management system, comprising: dividing job descriptions into structured J SON sections at nested boundaries for distinct requirements; generating vector embeddings for each section using generative AI and storing these in a vector-based search index; and using similarity scoring to retrieve and assemble templates from independently matched sections, allowing efficient retrieval and customization of job descriptions based on specific organizational needs.

Clause 26. A method for processing job skills requirements from a job description text, comprising: identifying individual skills from the job description as required skills; categorizing the identified individual skills into a SkillSet section; extracting and organizing skill groups into a skillsGroup section from the job description based on logical relationships between skills, including “AND” and “OR” conditions. processing the logical relationships using a skillsGroupGate section, wherein: “AND” groups are treated as mandatory required groups “OR” groups occurring after an “AND” group are treated as either/or groups until the next “AND” group; Subsequent “AND” groups are treated as additional mandatory required groups; generating a structured representation of the job skills requirements by integrating the SkillSet, skillsGroup, and skillsGroupGate sections.

Clause 27. The method of clause 21, wherein the SkillSet section comprises individual skills that must be satisfied independently of the logical relationships within the skillsGroup section.

Clause 28. The method of clause 21, wherein the skillsGroup section comprises skill groups defined by the logical relationships, including: one or more skills combined using an “AND” condition to form a required group, and one or more skills combined using an “OR” condition to form an either/or group.

Clause 29. The method of clause 21, further comprising dynamically updating the skillsGroupGate section when additional “AND” or “OR” conditions are identified in the job description text.

Clause 30. A method for generating strings to group or cluster J SON objects based on job skills requirements, comprising: constructing strings that represent the relationships within the SkillSet and skillsGroup sections, wherein: “AND” conditions are used to concatenate mandatory skills or groups; “OR” conditions are used to concatenate skills or groups that satisfy either/or conditions; ensuring the generated strings preserve the hierarchical and logical structure of the job skills requirements for accurate grouping or clustering of JSON objects.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A method comprising:
obtaining a plurality of documents, each document representing unstructured data;
for each document, generating a nested database object of a plurality of nested database objects by:
performing optical character recognition on each document to produce document data associated with each document;
the nested database object comprising nested database object sections comprising:
a JobSkillsRequirement section comprising:
a SkillSet subsection that lists individual required skills, and
a skillsGroup subsection that encodes logic gating semantics for skill groups; and
generating, for each JobSkillsRequirement section, a concatenated representation of the SkillSet and skillsGroup subsections that preserves the logic gating semantics;
constructing a document similarity graph by computing similarity scores between the concatenated representations and one or more other nested database object sections, wherein each node in the document similarity graph represents a document of the plurality of documents, the document similarity graph being configured to enable scalable management of a plurality of documents in at least one database, and wherein edges between nodes of the document similarity graph are formed where a similarity score between the concatenated representations of the nodes exceed a predetermined threshold;
utilizing at least one graph partitioning model to partition the document similarity graph into clusters to group the plurality of nested database objects into a plurality of document clusters based at least in part on at least one similarity measure of the document similarity graph;
utilizing at least one generative model to generate, for each cluster, from the at least one nested database object, at least one vector embedding representing at least one template document requirement based at least in part on the nested database object sections and the concatenated representation;
filtering a plurality of data profiles based at least in part on the at least one document template requirement to obtain at least one candidate data profile; and
outputting, via a display, the at least one candidate data profile.

2. The method of claim 1, wherein the plurality of documents comprise a plurality of job descriptions (JDs) in a structured JavaScript Object Notation (JSON) format.

3. The method of claim 2 further comprising:
receiving the plurality of job description documents in various formats;
converting unstructured formats, using Optical Character Recognition (OCR) and Named Entity Recognition (NER);
extracting portions of the document data comprising job-related information; and
organizing the job-related information into JSON sections, including job details, skills, education, and experience requirements, for storage in a database.

4. The method of claim 2, wherein the structured JSON format organizes data into nested JSON elements, comprising at least one of JobDetailsRequirement, JobSkillsRequirement, or EducationAndExperienceRequirement, enabling modular access to distinct job requirements.

5. The method of claim 2, further comprising:
dividing each job description into structured JSON chunks at nested-JSON boundaries, where each chunk corresponds to distinct requirements such as JobDetailsRequirement, JobSkillsRequirement, and EducationAndExperienceRequirement; and
storing the JSON chunks in a structured database for efficient retrieval and modular management.

6. The method of claim 3, further comprising a clustering algorithm to group a plurality of job descriptions with similar requirements based on attributes such as skills, experience, and education.

7. The method of claim 3, further comprising clustering job descriptions to create templates, comprising:
using similarity scoring techniques, comprising at least one of Term Frequency-Inverse Document Frequency (TF-IDF), cosine, or Jaccard similarity, to measure document similarity and identify clusters;
generating a standardized template for each cluster using the at least one generative model, ensuring alignment with industry standards; and
storing templates in JSON format for modular access and retrieval.

8. The method of claim 5, wherein clustering is performed using graph partitioning techniques that group job descriptions without a pre-specified number of clusters, allowing dynamic clustering based on similarity scores.

9. The method of claim 5, further comprising using vector-based indexing and retrieval of job descriptions, comprising:
converting the nested-JSONs of job descriptions into vector representations using the at least one generative model; and
storing the vector representations in a vector-based search index, allowing independent retrieval of structured sections.

10. The method of claim 5, further comprising generating strings to group or cluster JSON objects based on job skills requirements, comprising:
constructing strings that represent relationships within the SkillSet section and the skillsGroup section, wherein:
“AND” conditions are used to concatenate mandatory skills or groups;
“OR” conditions are used to concatenate skills or groups that satisfy either/or conditions; and
ensuring the generated strings preserve a hierarchical and logical structure of the job skills requirements for accurate grouping or clustering of JSON objects.

11. A system comprising:
at least one processor in communication with at least one non-transitory computer-readable medium having software instructions stored thereon, wherein the at least one processor, upon execution of the software instructions, is configured to:
obtain a plurality of documents, each document representing unstructured data;
for each document, generate a nested database object of a plurality of nested database objects by:
performing optical character recognition on each document to produce document data associated with each document;
the nested database object comprising nested database object sections comprising:
a JobSkillsRequirement section comprising:
a SkillSet subsection that lists individual required skills, and
a skillsGroup subsection that encodes logic gating semantics for skill groups; and
generate, for each JobSkillsRequirement section, a concatenated representation of the SkillSet and skillsGroup subsections that preserves the logic gating semantics;
construct a document similarity graph by computing similarity scores between the concatenated representations and one or more other nested database object sections, wherein each node in the document similarity graph represents a document of the plurality of documents, the document similarity graph being configured to enable scalable management of a plurality of documents in at least one database, and wherein edges between nodes of the document similarity graph are formed where a similarity score between the concatenated representations of the nodes exceed a predetermined threshold;
utilize at least one graph partitioning model to partition the document similarity graph into clusters to group the plurality of nested database objects into a plurality of document clusters based at least in part on at least one similarity measure of the document similarity graph;
utilize at least one generative model to generate, for each cluster, from the at least one nested database object, at least one vector embedding representing at least one template document requirement based at least in part on the nested database object sections and the concatenated representation;
filter a plurality of data profiles based at least in part on the at least one document template requirement to obtain at least one candidate data profile; and
output, via a display, the at least one candidate data profile.

12. The system of claim 11, wherein the plurality of documents comprise a plurality of job descriptions (JDs) in a structured JavaScript Object Notation (JSON) format.

13. The system of claim 12, wherein the at least one processor, upon execution of the software instructions, is further configured to:
receive the plurality of job description documents in various formats;
convert unstructured formats, using Optical Character Recognition (OCR) and Named Entity Recognition (NER);
extract portions of the document data comprising job-related information; and
organize the job-related information into JavaScript Object Notation (JSON) sections, including job details, skills, education, and experience requirements, for storage in a database.

14. The system of claim 12, wherein the structured JSON format organizes data into nested JSON elements, comprising at least one of JobDetailsRequirement, JobSkillsRequirement, or EducationAndExperienceRequirement, enabling modular access to distinct job requirements.

15. The system of claim 12, wherein the at least one processor, upon execution of the software instructions, is further configured to:
divide each job description into structured JSON chunks at nested-JSON boundaries, where each chunk corresponds to distinct requirements such as JobDetailsRequirement, JobSkillsRequirement, and EducationAndExperienceRequirement; and
store the JSON chunks in a structured database for efficient retrieval and modular management.

16. The system of claim 13, wherein the at least one processor, upon execution of the software instructions, is further configured to utilize a clustering algorithm to group a plurality of job descriptions with similar requirements based on attributes such as skills, experience, and education.

17. The system of claim 13, wherein the at least one processor, upon execution of the software instructions, is further configured to cluster job descriptions to create templates, comprising:
using similarity scoring techniques, including Term Frequency-Inverse Document Frequency (TF-IDF), cosine, or Jaccard similarity, to measure document similarity and identify clusters;
generating a standardized template for each cluster using the at least one generative model, ensuring alignment with industry standards; and
storing templates in JSON format for modular access and retrieval.

18. The system of claim 15, wherein clustering is performed using graph partitioning techniques that group job descriptions without a pre-specified number of clusters, allowing dynamic clustering based on similarity scores.

19. The system of claim 15, wherein the at least one processor, upon execution of the software instructions, is further configured to use vector-based indexing and retrieval of job descriptions, comprising:
converting the nested-JSONs of job descriptions into vector representations using the at least one generative model; and
storing the vector representations in a vector-based search index, allowing independent retrieval of structured sections.

20. The system of claim 15, wherein the at least one processor, upon execution of the software instructions, is further configured to generate strings to group or cluster JSON objects based on job skills requirements, comprising:
constructing strings that represent relationships within the SkillSet section and the skillsGroup section, wherein:
“AND” conditions are used to concatenate mandatory skills or groups;
“OR” conditions are used to concatenate skills or groups that satisfy either/or conditions;
ensuring the generated strings preserve a hierarchical and logical structure of the job skills requirements for accurate grouping or clustering of JSON objects.
